(19) United States
(12) Patent Application Publication
(10) Pub. No.: US 2001/0006718 A1
(43) Pub. Date: Jul. 5, 2001

(54) Markings on transparent plastic

(76) Inventor: Gerhard Jorgen Darr, Ballerup (DK)

Correspondence Address: Steve T. Zelson, Esq., Novo Nordisk of North America, Inc., 405 Lexington Avenue, Suite 6400, New York, NY, 10174-6401, US

(21) Appl. No.: 09/732,398

(22) Filed: Dec. 7, 2000

Related U.S. Application Data
(60) Provisional application No. 60/174,656, filed on Jan. 6, 2000.

(30) Foreign Application Priority Data
Dec. 22, 1999 (DK) PA 1999 01835

(51) Int. Cl. B32B 3/30

(52) U.S. Cl. 428/156

(57) ABSTRACT

A marking on a transparent plastic member is formed by an array of uniform protrusions on the rear side of the transparent plastic member.

### CROSS-REFERENCE TO RELATED APPLICATIONS

This application claims priority under 35 U.S.C. 119 of U.S. provisional application Ser. Nos. 60/174,656 filed on Jan. 6, 2000 and Danish application no. PA 1999 01835 filed on Dec. 22, 1999, the contents of which are fully incorporated herein by reference.

The invention relates to writings and markings on transparent plastic, especially packagings.

Packagings made from plastic materials are often provided with markings and writings which may indicate how the packaging should be handled to obtain access to its content, information about the content, etc. The markings and writings may be printed or serigraphed onto the surface of the packaging material. Alternatively the markings and writings may be made on a label, which is glued onto the packaging. Another possibility is to provided the markings and writings by stamping them into the cured plastic material by a hot die or by a cold die before the plastic material is totally cured. Alternatively the marking may be moulded in the plastic surface by the moulding process by which the packaging is manufactured.

Printing, serigraphing, stamping and labelling all involves an extra step in the manufacturing process, which may be avoided if the moulding solution is used. However markings provided by moulding may in some lightings be difficult to see or even practically invisible.

Consequently it is an objective of the invention to provide a transparent plastic member with writings or markings which are visible in most lightings.

This is according to the invention obtained by forming the writing or marking as an array of uniform protrusions on the rear side of the transparent plastic element. By the rear side is meant the side of the plastic material lying opposite the surface on which the writing or marking shall be read.

The protrusions may according to an embodiment of the invention have the shape of spherical segments.

In the following the invention is described in further aspects with references to the figures of which

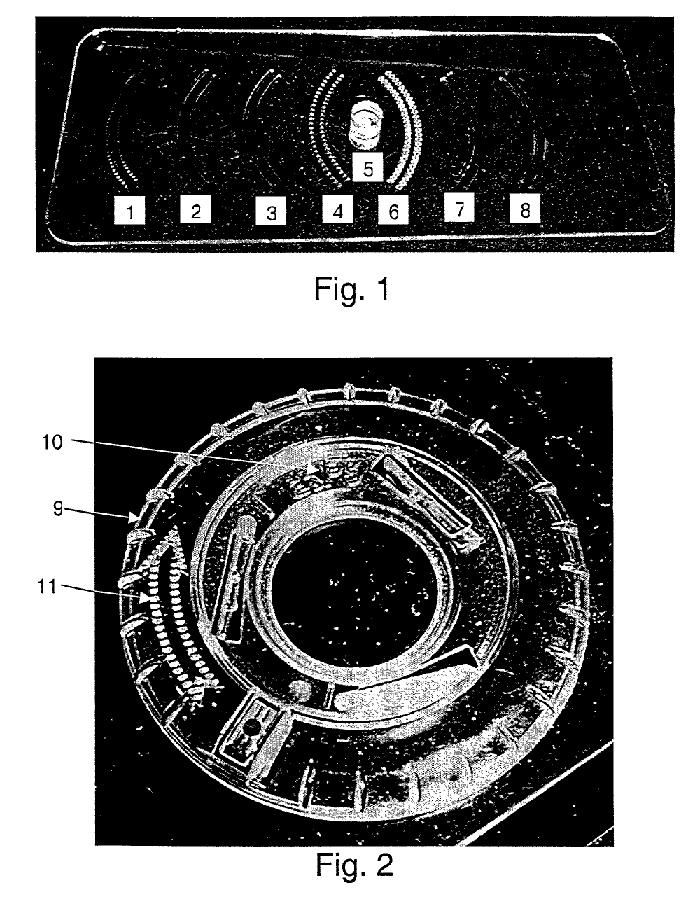

FIG. 1 shows a photo of a transparent plastic sheet with different samples of a marking.

FIG. 2 shows a photo of the a rotatable lid of a pill dispenser, on which lid the prescribed rotation direction is indicated by a marking made according to the invention.

In FIG. 1 a thin transparent plastic sheet is shown in which sheet are formed a number of samples of a marking appearing as a double lined arch of a circle by the injection moulding of said sheet.

The markings 1 - 4 are made as depressions in the front surface of the sheet, i.e. the surface on which the marking is seen, and read if the marking is an inscription. In sample 1 the arches are formed by a row of pyramid shaped depressions in the front surface of the plastic sheet. In the samples 2 and 3 the arches are formed as continuous grooves in the front surface, the grooves in sample 2 having a V-shaped cross section and the grooves in sample 3 having a U-shaped cross section. In sample 4 the arches are formed by an array of depressions in the front side, the impressions having the shape of spherical segments.

The light cylinder 5 is not a sample but is a dead head of material originating from the injection moulding of the plastic sheet.

The markings 6 - 8 are made as protrusions on the rear surface of the plastic sheet. In sample 6 the double arch is formed by an array of uniform circular protrusions having the shape of half spheres. In the samples 7 and 8 the arches are formed at continuous ribs on the rear side of the plastic sheet, the ridges in sample 7 having a U-shaped cross section and the ridges in sample 8 having a V-shaped cross section.

The sheet in FIG. 1 is shown in a lighting by which the samples 1- 4 and 7 - 8 are only moderate visible, whereas the sample 6 appears almost luminous. In other lightings one or more of the other samples may be fairly visible whereas the sample 6 due to the rotation symmetrical shape of the individual protrusions will maintain its almost luminous appearance by all lightings. It is further noticed that markings, depressed or protruding, on the rear side of a transparent sheet as a whole appears clearer visible than markings in the front side, and that markings made according to the invention, i.e. as an array of uniform circular protrusions on the rear side of a transparent member, are clearly almost luminous appearing notwithstanding the angle of incidence of the light.

FIG. 2 shows a rotatable lid 9 of a pillbox, which lid is marked with an arrow 11 indicating the prescribed direction of rotation. The lid further is provided with a marking 10 indicating information concerning the manufacturing which marking is hidden when the lid is mounted on the pillbox as it is of no interest for the user. This marking is made in a traditional way as a protruding writing on the front side of the lid and is not easily readable whereas the arrow, which is made according to the invention, appears almost luminous.

Although the invention is mainly described for use by marking packaging material, the technique defined by the invention may also be used to enhance the legibility of badges, sign boards and pictograms.

What is claimed is:

1. A writing or marking on a transparent plastic member, characterised in that the writing or marking is formed by an array of uniform protrusions on the rear side of the transparent plastic member.

2. A writing or marking on a transparent plastic member according to claim 1, characterised in that the protrusions are rotation symmetric.

3. A writing or marking on a transparent plastic member according to claim 2, characterised in that the protrusions are circular.

4. A writing or marking on a transparent plastic member according to claim 3, characterised in that the protrusions has the shape spherical segments.

5. A writing or marking on a transparent plastic member according to claim 4, characterised in that the protrusions has the shape of half spheres.

6. A writing or marking on a transparent plastic member according to claim 1, characterised in that the plastic member forms a part of a medical device.

7. A writing or marking on a transparent plastic member according to claim 1, characterised in that the plastic member forms a part of a packaging.
